(19) United States
(12) Patent Application Publication
(10) Pub. No.: US 2025/0198813 A1
(43) Pub. Date: Jun. 19, 2025

(54) Sensor System Emulating Variable Differential Transformer

(71) Applicant: Woodward, Inc., Fort Collins, CO (US)

(72) Inventor: Brian L. Swope, Janesville, WI (US)

(73) Assignee: Woodward, Inc., Fort Collins, CO (US)

(21) Appl. No.: 19/071,980

(22) Filed: Mar. 6, 2025

Related U.S. Application Data
(63) Continuation of application No. PCT/US2023/033979, filed on Sep. 28, 2023.
(60) Provisional application No. 63/412,795, filed on Oct. 3, 2022.

(51) Int. Cl. G01D 21/00; G01S 15/06

(52) U.S. Cl. CPC G01D 21/00; G01S 15/06

(57) ABSTRACT

Embodiments of the present disclosure relate to a system including a controller, a position sensor, and an emulator circuit. The controller is configured to output an AC excitation signal and receive a first AC response signal and a second AC response signal. The controller is configured to determine a position of an effector based on the first AC response signal and the second AC response signal. The position sensor is configured to be connected to the effector, and the position sensor is configured to output a position signal based on the position of the effector. The emulator circuit is configured to modulate the amplitude and frequency of the position signal based on the AC excitation signal to produce the first AC response signal and the second AC response signal.

### CROSS-REFERENCE TO RELATED PATENT APPLICATIONS

This patent application is a continuation of International Application No. PCT/US2023/033979, filed Sep. 28, 2023, which claims the benefit of U.S. Provisional Patent Application No. 63/412,795, filed Oct. 3, 2022, the entire teachings and disclosures of both of which are incorporated herein in their entireties by reference thereto.

### FIELD OF THE INVENTION

This invention generally relates to sensor systems and, in particular, position sensing systems.

### BACKGROUND OF THE INVENTION

Applicant expects that replacing linear variable differential transformers (LVDT) or rotary variable differential transformers (RVDT) with sensors of other types may provide certain advantages. For example, Applicant has found that LVDT and RVDT are comparatively large sensors that drive the ultimate size of the device to which they are attached for position sensing. Further, Applicant has found that, for a given sensor package size, other sensors (such as an ultrasonic position sensor) may be more accurate than LVDT and RVDT. Thus, by replacing an LVDT or an RVDT with another type of position sensor, Applicant expects that the size and weight of the device can be reduced while also increasing the accuracy of position sensing.

However, in certain circumstances, the position sensed by a conventional LVDT or RVDT may be used by the full authority digital engine control (FADEC) or electronic engine control unit (EECU). The FADEC or EECU, by design, control all aspects of engine performance. The FADEC or EECU is, thus, configured to receive a certain type of input associated with an LVDT or RVDT, in particular an AC signal in a certain amplitude range and of a certain frequency. As such, a conventionally used LVDT or RVDT cannot be replaced with another sensor type without modifying the FADEC or EECU. Because of the number of operations managed by the FADEC or EECU, modifications to the FADEC or EECU must be thoroughly vetted for performance and safety before adoption. Accordingly, the FADEC and EECU are typically not modified, which means that an LVDT or RVDT must continue to be used and which means that the advantages associated with other position sensor types cannot be realized.

### BRIEF SUMMARY OF THE INVENTION

Embodiments of the present disclosure address the foregoing issues of replacing an LVDT or an RVDT with another position sensor type. In particular, embodiments of the present disclosure relate to a system in which the position sensor type is made to emulate an LVDT or RVDT signal such that no modification has to be made to the FADEC or EECU to utilize the different position sensor type. These and other advantages of the invention, as well as additional inventive features, will be apparent from the description of the invention provided herein.

Aspect 1 relates to an emulator circuit configured to receive an AC excitation signal from a controller and to receive a position signal from a position sensor connected to an effector. The position signal is indicative of a position of the effector. The emulator circuit includes means for modulating an amplitude and a frequency of the position signal based on the AC excitation signal to produce a first AC response signal and a second AC response signal. The first AC response signal and the second AC response signal are configured to be used by the controller for determining the position of the effector.

Aspect 2 relates to the emulator circuit of Aspect 1 in which the means for modulating includes a first analog amplitude modulator and a second analog amplitude modulator. The position signal includes a first position signal and a second position signal. The first position signal is an input of the first analog amplitude modulator, and the second position signal is an input of the second analog amplitude modulator. The AC excitation signal is an input of each of the first analog amplitude modulator and the second analog amplitude modulator. The first analog amplitude modulator multiplies the first position signal by the AC excitation signal to produce the first AC response signal, and the second analog amplitude modulator multiplies the second position signal by the AC excitation signal to produce the second AC response signal.

Aspect 3 relates to the emulator circuit of Aspect 2 in which the second position signal is inverse to the first position signal.

Aspect 4 relates to the emulator circuit of Aspect 2 or Aspect 3 in which the first analog amplitude modulator is contained on a single integrated circuit and in which the second analog amplitude modulator is contained on a single integrated circuit.

Aspect 5 relates to the emulator circuit of any one of Aspects 2-4 in which the first analog amplitude modulator and the second analog amplitude modulator are constructed with high-temperature transistors.

Aspect 6 relates to the emulator circuit of any one of Aspects 2-5 in which the first position signal is amplified or attenuated before being input to the first analog amplitude modulator and in which the second position signal is amplified or attenuated before being input to the second analog amplitude modulator.

Aspect 7 relates to the emulator circuit of any one of Aspects 2-5 in which the means for modulating includes a digital signal processor (DSP), a first digital-to-analog converter (DAC), and a second DAC. The position signal is input to the DSP, and the DSP produces the first position signal and the second position signal based on the position signal and outputs the first position signal to the first DAC and the second position signal to the second DAC. The first DAC converts the first position signal to a first analog position signal and outputs the first analog position signal to the first analog amplitude modulator, and the second DAC converts the second position signal to a second analog position signal and outputs the second analog position signal to the second analog amplitude modulator.

Aspect 8 relates to the emulator circuit of any of Aspects 2-7 in which the AC excitation signal is amplified prior to being input to the first analog amplitude modulator and the second analog amplitude modulator.

Aspect 9 relates to the emulator circuit of any of Aspects 2-8 in which the AC excitation signal is phase shifted 180° before being input to the second analog amplitude modulator.

Aspect 10 relates to the emulator circuit of Aspect 1 in which the means for modulating includes a digital signal processor (DSP), a first digital-to-analog converter (DAC), a second DAC, and an analog-to-digital converter (ADC). The ADC converts the AC excitation signal to a digital excitation signal and outputs the digital excitation signal to the DSP. The position signal is input to the DSP, and the DSP produces a first digital position signal and a second digital position signal based on the position signal and the digital excitation signal and outputs the first digital position signal to the first DAC and the second digital position signal to the second DAC. The first DAC converts the first digital position signal to a first analog signal and outputs the first analog signal as the first AC response signal to the controller, and the second DAC converts the second digital position signal to a second analog signal and outputs the second analog signal as the second AC response signal to the controller.

Aspect 11 relates to the emulator circuit of Aspect 10 in which the AC excitation signal is amplified before being input to the ADC.

Aspect 12 relates to the emulator circuit of Aspect 10 or Aspect 11 in which the second digital position signal is inverse to the first digital position signal.

Aspect 13 relates to a system. The system includes a controller configured to output an AC excitation signal and receive a first AC response signal and a second AC response signal. The controller is configured to determine a position of an effector based on the first AC response signal and the second AC response signal. The system also includes a position sensor configured to be connected to the effector. The position sensor is configured to output a position signal based on the position of the effector. The system further includes an emulator circuit configured to modulate an amplitude and a frequency of the position signal based on the AC excitation signal to produce the first AC response signal and the second AC response signal. The emulator circuit is, in particular, the emulator circuit of any one of Aspects 1-12.

Aspect 14 relates to the system according to Aspect 13 in which the controller includes a first terminal and a second terminal configured to produce the AC excitation signal. The emulator circuit includes a first impedance matching circuit configured to mimic a primary coil of a variable differential transformer, and the first impedance matching circuit is disposed between the first terminal and the second terminal.

Aspect 15 relates to the system according to Aspect 13 or Aspect 14 in which the controller comprises a third terminal, a fourth terminal, and one or more ground terminals. The third terminal is configured to receive the first AC response signal, and the fourth terminal is configured to receive the second AC response signal. The emulator circuit includes a second impedance matching circuit configured to mimic a first secondary coil of a variable differential transformer, and the second impedance matching circuit is disposed between the third terminal and the one or more ground terminals. The emulator circuit also includes a third impedance matching circuit configured to mimic a second secondary coil of the variable differential transformer, and the third impedance matching circuit is disposed between the fourth terminal and the one or more ground terminals.

Aspect 16 relates to the system according to any one of Aspects 13-15 further including a plurality of isolation transformers disposed between the emulator circuit and the controller.

Aspect 17 relates to the system according to any one of Aspects 13-16 in which the position sensor is an ultrasonic sensor, a Hall effect sensor, an eddy current sensor, a capacitive displacement sensor, an inductive sensor, a laser Doppler vibrometer, a photodiode array, a piezoelectric transducer, a position encoder, a potentiometer, an optical proximity sensor, or a string potentiometer.

Aspect 18 relates to a method. In the method, an AC excitation signal is first output from a controller to an emulator circuit. In the method, a position signal is second output from a position sensor to the emulator circuit. The position sensor is connected to an effector. In the method, an amplitude and a frequency of the position signal is modulated to produce a first AC response signal and a second AC response signal. In the method, the first AC response signal and the second AC response signal are input to the controller, and in the method, a position of the effector is determined by the controller based on the first AC response signal and the second AC response signal.

Aspect 19 relates to the method of Aspect 18 in which the first outputting further includes outputting the AC excitation signal to a first analog amplitude modulator and to a second analog amplitude modulator. The second outputting further includes outputting the position signal having a first position signal and a second position signal. The first position signal is an input of the first analog amplitude modulator, and the second position signal is an input of the second analog amplitude modulator. Modulating further includes multiplying the first position signal by the AC excitation signal at the first analog amplitude modulator to produce the first AC response signal and multiplying the second position signal by the AC excitation signal at the second analog amplitude modulator to produce the second AC response signal.

Aspect 20 relates to the method of Aspect 19 in which the emulator circuit includes a digital signal processor (DSP), a first digital-to-analog converter (DAC), and a second DAC. The second outputting further includes outputting the position signal to the DSP. Modulating further includes producing, by the DSP, the first position signal and the second position signal based on the position signal; outputting the first position signal to the first DAC and the second position signal to the second DAC; converting, by the first DAC, the first position signal to a first analog position signal; converting, by the second DAC, the second position signal to a second analog position signal; and outputting the first analog position signal to the first analog amplitude modulator and the second analog position signal to the second analog amplitude modulator.

Aspect 21 relates to the method of Aspect 18 in which the emulator circuit includes a digital signal processor (DSP), a first digital-to-analog converter (DAC), a second DAC, and an analog-to-digital converter (ADC). The first outputting further includes converting, by the ADC, the AC excitation signal to a digital excitation signal and outputting the digital excitation signal to the DSP. The second outputting further comprises outputting, by the position sensor, the position signal to the DSP. Modulating further includes producing, by the DSP, a first digital position signal and a second digital position signal based on the position signal and the digital excitation signal; outputting the first digital position signal to the first DAC and the second digital position signal to the second DAC; converting, by the first DAC, the first digital position signal to a first analog signal; and converting, by the second DAC, the second digital position signal to a second analog signal. Inputting further includes outputting, by the first DAC, the first analog signal as the first AC response signal to the controller and outputting, by the second DAC, the second analog signal as the second AC response signal to the controller.

Aspect 22 relates to the method according to any one of Aspects 18-21, in which the emulator circuit is isolated from the controller via a plurality of isolating transformers.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a schematic representation of system including an analog variable differential transformer emulator circuit, according to an exemplary embodiment;

FIG. 2 is a schematic representation of a system including a mixed analog-digital variable differential transformer emulator circuit, according to an exemplary embodiment;

FIG. 3 is a schematic representation of a system including a fully digital variable differential transformer emulator circuit, according to an exemplary embodiment;

FIG. 4 is a schematic representation of a system including an analog variable differential transformer emulator circuit that is isolated using transformers from the controller, according to an exemplary embodiment;

FIGS. 5A-5E are graphs of an AC excitation signal, position signal, modulated position signal, inverted position signal, modulated inverted position signal, and demodulated signals involved in determining a position by a controller, according to an exemplary embodiment; and

FIG. 6 depicts a schematic representation of a system configured to determine a position based on modulation and demodulation of a position sensor signal, according to an exemplary embodiment.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

LVDT and RVDT operate in substantially the same manner. In particular, they both use a primary transformer coil that energizes two secondary transformer coils. A ferromagnetic core is connected to an effector, and movement of the core (based on the position of the effector) relative to the two secondary coils produces varying voltages across the two secondary coils. The voltage difference between the secondary transformer coils can thus be used to determine the position of the core and therefore the effector. An LVDT has a core connected to an effector that moves linearly, and an RVDT has a core connected to an effector that moves rotationally. Because the position of the core is determined using electrical principles associated with transformers, the FADEC or EECU outputs an AC excitation signal for the primary transformer coil, and the FADEC or EECU is configured to receive AC response signals from the two secondary transformer coils. Sensors that do not operate using transformers do not utilize the AC excitation signal or produce the two corresponding AC response signals. Further, the FADEC or EECU will not be able to interpret the sensor data received from non-transformer position sensors.

According to embodiments of the present disclosure, various circuit configurations are provided to emulate an LVDT or RVDT (hereinafter collectively referred to as just “VDT”) response signal using the excitation signal from the FADEC or EECU (hereinafter collectively referred to as “controller”). As will be discussed more fully below, the sensor output is amplitude modulated using the excitation signal produced by the controller. The modulation may be done using analog components or digital components, including using software. Further, the system configurations include an impedance matching circuit so that built-in test circuits operated by the controller sense a VDT connected to the controller. These and other aspects and advantages will be described more fully below and in relation to the appended drawings. The embodiments presented herein are provided by way of illustration and not limitation.

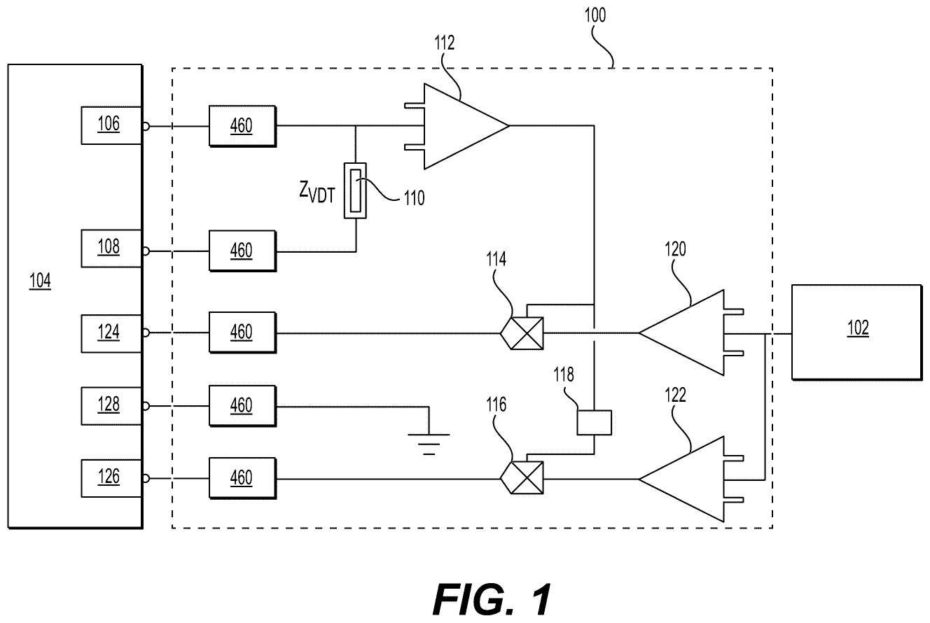

FIG. 1 depicts an embodiment of a system including an analog circuit 100 with means for emulating a VDT signal from a position sensor 102. In the system, the emulator circuit 100 is in communication with a controller 104 configured to produce an AC excitation signal from a first terminal 106 and a second terminal 108. In one or more embodiments, an impedance matching circuit 110 is disposed between the first terminal 106 and the second terminal 108. In this way, built-in test circuitry of the controller 104 senses an impedance associated with a connected VDT. Because the controller 104 still senses a VDT, the controller 104 does not report an error, which could prevent operation of the system controlled by the controller 104. In one or more embodiments, the AC excitation signal is amplified or attenuated using a first amplifier 112.

In the configuration of the analog emulator circuit 100 shown in FIG. 1, the AC excitation signal is an input to a first amplitude modulator 114 and to a second amplitude modulator 116. In one or more embodiments, the AC excitation signal for the second amplitude modulator 116 is inverted via a 180° phase shift circuit 118. The first amplitude modulator 114 and the second amplitude modulator 116 each also receive an input from the position sensor 102. In one or more embodiments, the position sensor 102 outputs a position signal to the first amplitude modulator 114 and to the second amplitude modulator 116. In one or more embodiments, the first amplitude modulator 114 receives the position signal, and the second amplitude modulator 116 receives an inverted position signal. The position signals from the position sensor 102 are multiplied by the excitation signal at each of the first amplitude modulator 114 and the second amplitude modulator 116. In many instances, the output signal of the position sensor will be a varying analog signal proportional to the position sensed by the position sensor 102, and this signal will likely not be sinusoidal and may be close to a DC signal. By multiplying the output signal of the position sensor 102 by the excitation signal, the first amplitude modulator 114 and the second amplitude modulator 116 create and output respective AC signals, emulating the AC response signals associated with the response signals from the two secondary coils of a VDT.

In one or more embodiments, the position signals from the position sensor 102 are amplified or attenuated. In one or more embodiments, including the embodiment shown in FIG. 1, a first position signal from the position sensor 102 is amplified or attenuated on a second amplifier 120, and a second position signal, which may be an inverse signal as mentioned above, is amplified or attenuated on a third amplifier 122. In one or more embodiments, the third amplifier 122 inverts the position signal from the position sensor 102 (i.e., the third amplifier 122 is an inverting amplifier). In one or more embodiments, the amplified or attenuated first position signal is an input of the first amplitude modulator 114, and the amplified or attenuated second position signal is an input of the second amplitude modulator 116.

The controller 104 has a third terminal 124 configured to receive the output of the first amplitude modulator 114 and a fourth terminal 126 configured to receive the output of the second amplitude modulator 116. In one or more embodiments, including the embodiment depicted, the controller 104 also includes a fifth terminal 128 connected to ground (which may correspond to the center tap connection between the secondary coils of the VDT). However, in one or more other embodiments, the controller 104 includes a sixth terminal (e.g., for a six-wire VDT) that is also connected to ground. In this way, the controller 102 receives two AC response signals emulating the output of secondary coils of a VDT.

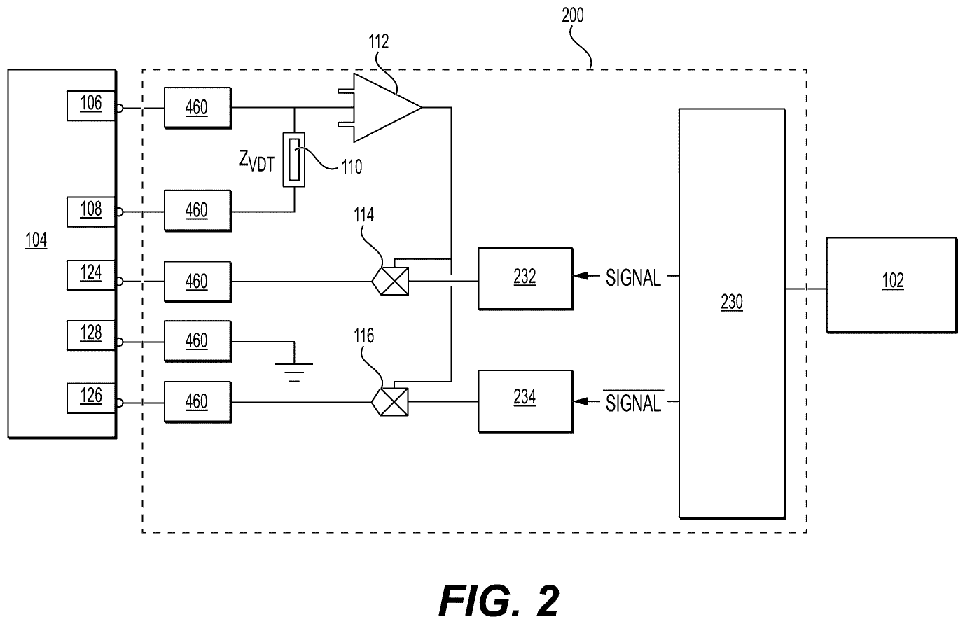

FIG. 2 depicts an embodiment of a system including a digital circuit 200 with means for emulating a VDT from a position sensor 102. The circuit 200 is digital at least in part because the output of the position sensor 102 is processed in a digital signal processor (DSP) 230. The DSP 230 outputs a first position signal and a second position signal, which may be inverse to the first position signal. The first position signal is input to a first digital-to-analog converter (DAC) 232, and the second position signal is input to a second DAC 234. The DAC 232, 234 convert the digitally processed signal from the DSP 230 to analog signals. The analog signals from the DAC 232, 234 are input to the amplitude modulators 114, 116 where they are multiplied by the AC excitation signal from the controller 104. In this way, the analog signals from the DAC 232, 234 will be within the appropriate range expected by the controller 102 based on the amplitude and frequency of the AC excitation signal.

In one or more embodiments, the first amplitude modulator 114 and the second amplitude modulator 116 are commercially available products. For example, the amplitude modulators can be a single integrated circuit, such as an AD630 or AD534 available from Analog Devices, Inc., Norwood, MA. In one or more other embodiments, the modulator is constructed with transistors, such as bipolar junction transistors (BJT), metal-oxide-semiconductor field-effect transistors (MOSFET), junction field effect transistors (JFET), or bipolar MOSFETs (BiFET), amongst other possibilities. For example, GaN BJTs may be used for high temperature applications. For example, the high temperature BJTs may be used in a Gilbert cell multiplier circuit.

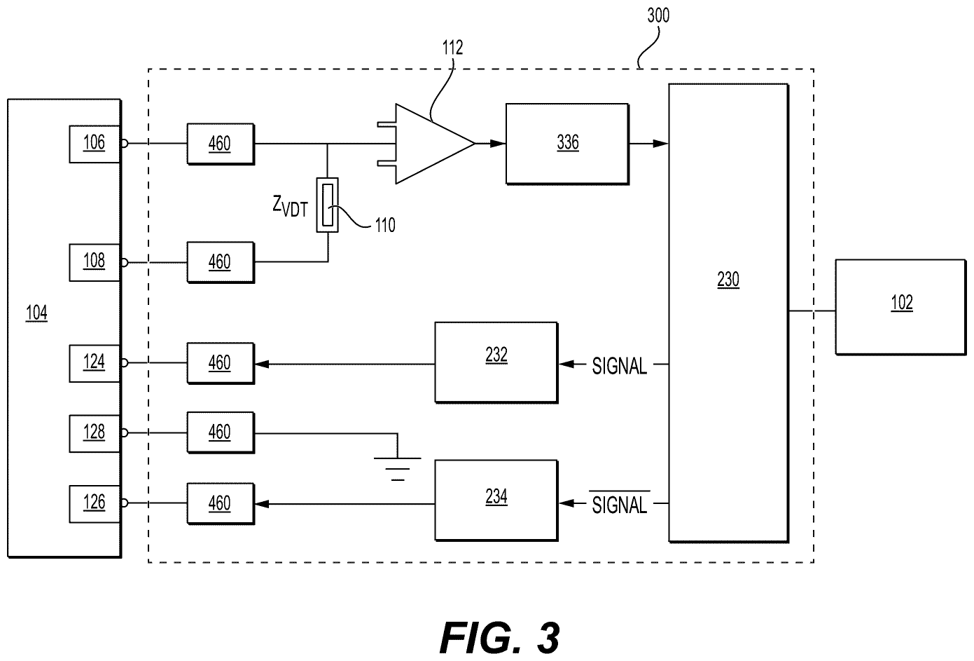

FIG. 3 depicts an embodiment of a system including an emulator circuit 300 in which the response signals are completely synthesized digitally. In one or more embodiments, the AC excitation signal from the controller 104 is converted to a digital signal using an analog-to-digital converter (ADC) 336. The digital signal output from the ADC 336 is input to the DSP 230. The DSP 230 also receives the output from the position sensor 102. Within the DSP 230, software or digital logic utilizes the digital excitation signal and the output signal from the position sensor 102 to produce the first position signal and second position signal, which may be inverse to the first position signal, at the desired amplitude and frequency. The first position signal is converted to an analog signal by the first DAC 232, and the second position signal is converted to an analog signal by the second DAC 234. In one or more embodiments, the position signals from the DAC 232, 234 are input directly to the third terminal 124 and fourth terminal 126 of the controller 104, in particular without requiring modulator circuits (such as amplitude modulators 114, 116).

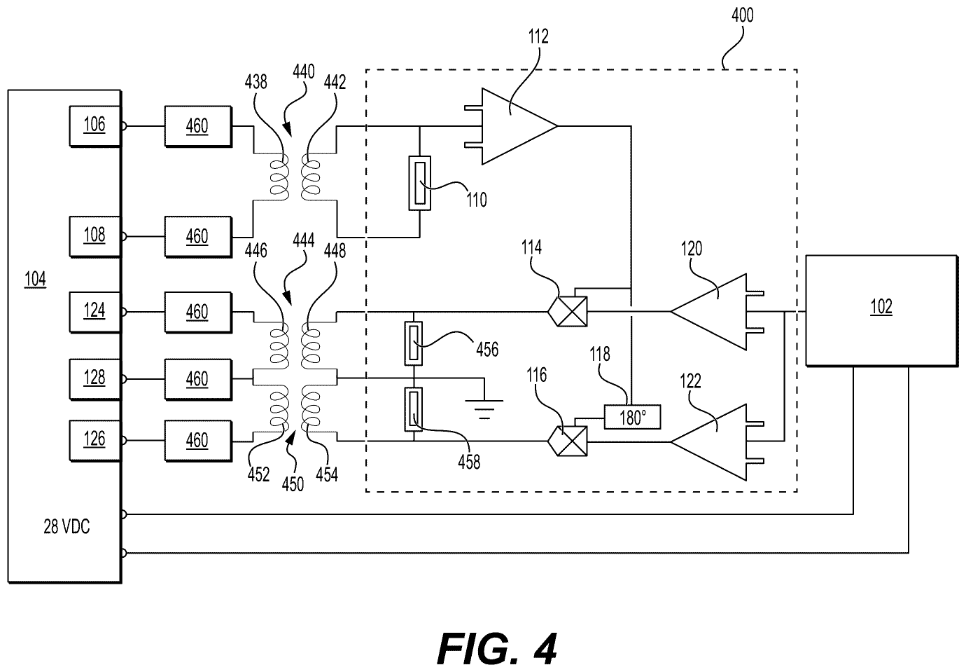

FIG. 4 depicts another embodiment of a system including an emulator circuit 400 with means for emulating a VDT that physically and electrically isolates the emulator circuit 400 from the controller 104. FIG. 4 depicts an emulator circuit 400 substantially similar to the embodiment of the emulator circuit 100 shown in FIG. 1. That is, the emulator circuit includes the AC excitation signal being fed as a first input into the first and second amplitude modulators 114, 116, and the first and second position signals from the position sensor 102 are fed as second inputs to the respective first and second amplitude modulators 114, 116. The first and second amplitude modulators 114, 116 output respective AC response signals for the controller 104.

However, in the embodiment shown in FIG. 4, the first terminal 106 and the second terminal 108 are connected to a first coil 438 of a first isolation transformer 440. A second coil of 442 of the first isolation transformer 440 is connected to the impedance matching circuit 110 and to the inputs of the first and second amplitude modulators 114, 116. A second isolation transformer 444 includes a first coil 446 between the third terminal 124 of the controller 104 and the fifth terminal 128 of the controller 104. A second coil 448 of the second isolation transformer 444 is connected between ground and the output of the first amplitude modulator 114. In this way, the second isolation transformer 444 transfers the first AC response signal to the controller 104 while being physically and electrically isolated from the controller 104. A third isolation transformer 450 includes a first coil 452 between the fourth terminal 126 and the fifth terminal 128 (or sixth terminal if provided) of the controller 104. A second coil 454 of the third isolation transformer 450 is connected between ground and the output of the second amplitude modulator 116. In this way, the third isolation transformer 450 transfers the second AC response signal to the controller 104 while being physically and electrically isolated from the controller 104.

While FIG. 4 depicts the output of amplitude modulators 114, 116 connected to the second coils 448, 454 of the second and third isolation transformers 444, 450, the second coils 448, 454 of the second and third isolation transformers 444, 450 can instead be connected to DAC 232, 234, such as shown in the embodiments of FIGS. 2 and 3. Further, while FIG. 4 depicts the second coil 442 of the first isolation transformer 440 connected as an input of the amplitude modulators 114, 116, the second coil 442 of the first isolation transformer 440 can instead be connected to an ADC 336, such as shown in FIG. 3.

FIG. 4 also depicts a second impedance matching circuit 456 connected between the output of the first amplitude modulator 114 and ground and a third impedance matching circuit 458 between the output of the second amplitude modulator 116 and ground. The second and third impedance matching circuits 456, 458 reflect and mimic the impedances from the secondary transformer coils of a conventional VDT so that built-in test circuitry of the controller 104 detects an appropriate response from the emulator circuit. In one or more embodiments, such impedance matching circuits 456, 458 are also included in the emulator circuits as shown in FIGS. 1-3.

FIGS. 1-4 also depict each of the emulator circuits 100, 200, 300, 400 including EMI/TVS circuits 460 that protect the controller 104 from electromagnetic interference and transient voltage spikes. Further, as shown in FIG. 4, the controller 104 may also power the position sensor 102, e.g., with 28 V DC power supply.

As discussed, the emulator circuits disclosed herein are designed to mimic the output of a VDT (either linear or rotary) for proper operation of the controller 104 (i.e., without requiring redesign of the controller 104). This allows for a wide range of position sensors to be controlled with the standard controller 104. In particular, the emulator circuit can be configured to work with all forms of standard position sensing equipment that provide analog voltage or frequency output. In one or more embodiments, the position sensor is an ultrasonic sensor (such as the ultrasonic position sensor disclosed in U.S. application Ser. No. 16/987,828, filed on Aug. 7, 2020, the entire contents of which are incorporated herein by reference in their entirety), a Hall effect sensor, an eddy current sensor, a capacitive displacement sensor, an inductive sensor, a laser Doppler vibrometer, a photodiode array, a piezoelectric transducer, a position encoder, a potentiometer, an optical proximity sensor, or a string potentiometer, amongst other possibilities.

An ultrasonic sensor of the type disclosed in the '828 application is especially suitable for use in a system with the disclosed emulator circuits 100, 200, 300, and 400. Such an ultrasonic sensor includes transceivers on each side of a moveable body within a fluid chamber, and as the moveable body is translated within the fluid chamber, the ultrasonic transceivers bounce ultrasonic signals off the moveable body. Based on the time that the ultrasonic signals take to reach the moveable body and bounce back to the respective ultrasonic transceivers, the position of the moveable body can be determined. The position in particular is proportional to (t₁−t₂)/(t₁+t₂), in which t₁ is the time after emitting the ultrasonic signal from the first ultrasonic transceiver that it takes for the ultrasonic signal to bounce from the moveable body and return to the first ultrasonic transceiver and in which t₂ is the time after emitting the ultrasonic signal from the second ultrasonic transceiver that it takes for the ultrasonic signal to bounce from the moveable body and return to the second ultrasonic transceiver. Advantageously, (t₁−t₂)/(t₁+t₂) correlates to the (V1−V2)/(V1+V2) ratiometric reading obtained from a VDT with the same benefits of being immune to DC shifts and common-mode amplitude changes.

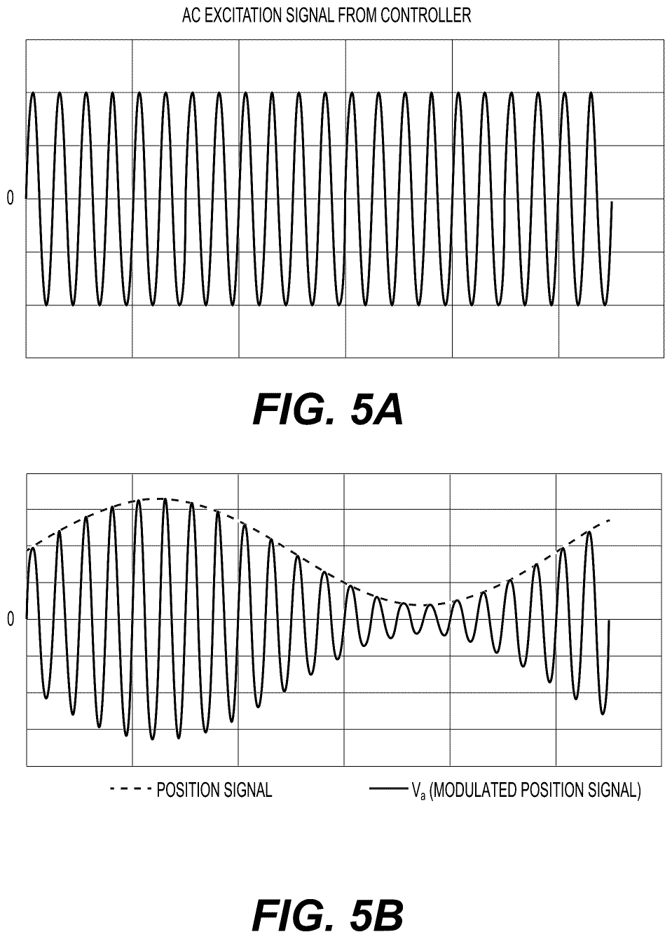

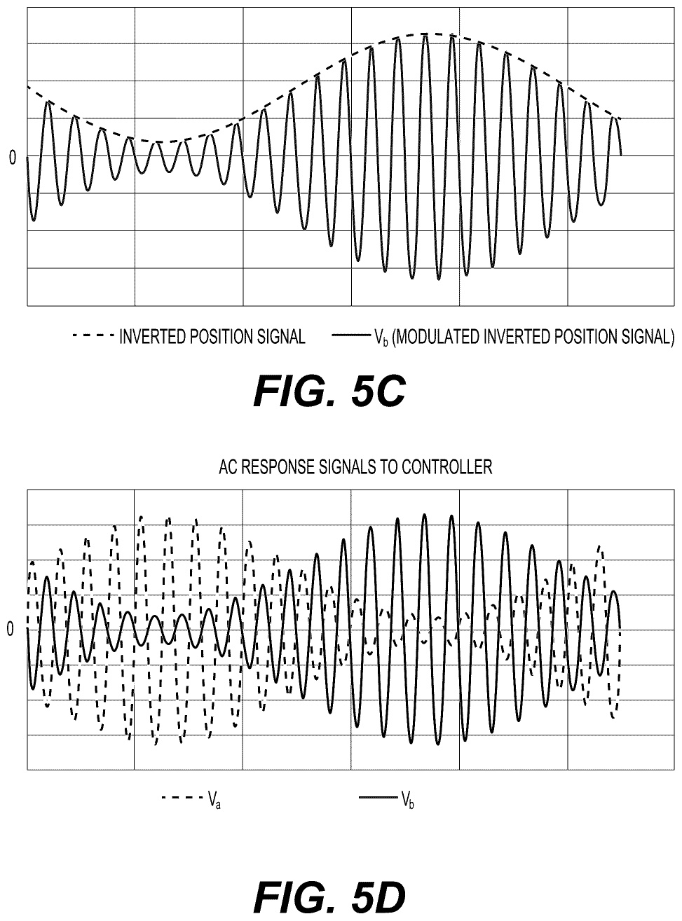

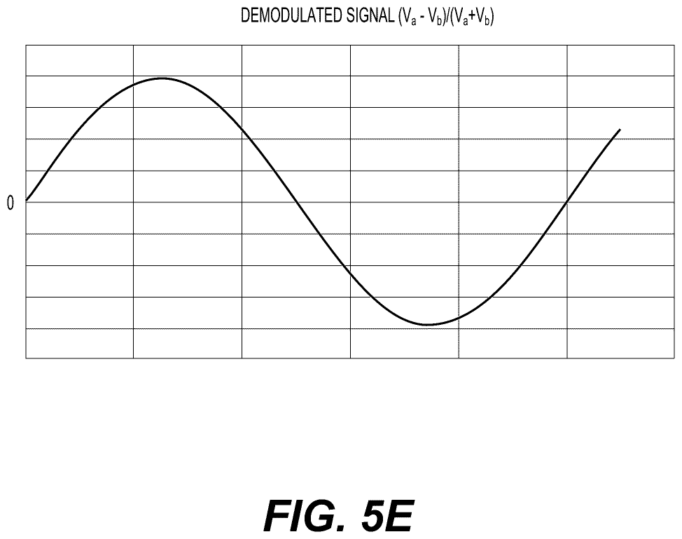

FIG. 5A-5E depict the signals involved in the determining of a position based on the position signal of a position sensor. FIG. 5A depicts a graph of the AC excitation signal generated by the controller. FIG. 5B depicts the position sensor signal in the dashed line. This signal is modulated by the AC excitation signal shown in FIG. 5A to produce the modulated signal shown in solid line in FIG. 5B. As discussed above, the position signal may be modulated using analog or digital components. In either case, the output is a voltage signal, shown as Vₐ. The position signal is also inverted as shown in FIG. 5C. In particular, the dashed line of FIG. 5C represents the inverted position signal. The inverted position signal is modulated based on the AC excitation signal to produce the modulated signal V_{b} shown in solid line in FIG. 5C. As with the other signal, the inverted position signal may be modulated using analog or digital components, and the output is also a voltage signal, shown as V_{b}. FIG. 5D depicts the modulated signals (Vₐ, V_{b}) that are designed to emulate a VDT. These signals are provided to the controller, which demodulates the signal using internal logic or programming to provide the demodulated signal (Vₐ−V_{b})/(Vₐ+V_{b}) as shown in FIG. 5E. This is the same calculation that that controller performs when it receives the voltage signals from a VDT, and thus, a controller configured to determine a position based on a VDT input can be used to determine a position form a non-VDT input.

As described, various embodiments of emulator circuits are provided that utilize the AC excitation signal and produce response signals in a manner that mimics a VDT. In this way, the controller is able to operate using substantially any position sensor without requiring reconfiguration or modification, which would necessitate significant testing and qualifying to be approved for use in in the field. Accordingly, the emulator circuits disclosed herein allow for replacement of VDT sensors, which improves accuracy and decreases sensor size, without requiring costly and time-intensive changes to the controller.

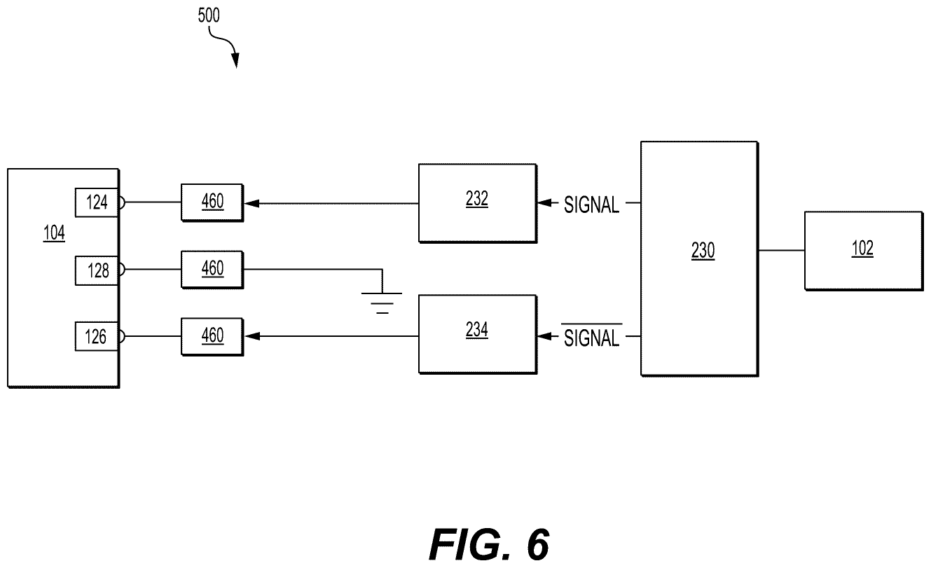

FIG. 6 depicts an embodiment of sensor system 500 for enhancing the accuracy of a sensor 102 in a noisy environment. In a variety of contexts, the controller 104 receives sensor input (e.g., fuel temperature, fuel level, fuel pressure, etc.) for controlling the engine. The sensor 102 may be, e.g., a thermocouple, a pressure sensor, a potentiometer, or a Hall effect sensor, among others. These sensors typically provide an analog signal, and the controller 104 utilizes the analog signal to control the engine. However, the accuracy of the signal may be improved, in particular by filtering out noise, by modulating the signal and then demodulating the signal in the controller.

As shown in FIG. 6, the sensor system 500 includes a DSP 230, which receives the sensor signal from the sensor 102. Within the DSP 230, software or logic modulates the sensor signal using an AC signal generated by the DSP 230. That is, the sensor signal is not modulated using an AC excitation signal generated by the controller 104 (because an AC excitation signal is not needed without a VDT). The DSP 230 outputs the modulated sensor signal to the first DAC 232, and the first DAC 232 converts the modulated digital sensor signal to a first analog signal for input to the controller 104. The DSP 230 also inverts the sensor signal and modulates the inverted sensor signal using the generated AC signal. The DSP outputs the modulated inverted sensor signal to the second DAC 234, and the second DAC 234 converts the modulated digital inverted sensor signal to a second analog signal for input to the controller 104. In the controller 104, the analog signals are demodulated, and the sensor output is determined.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An emulator circuit configured to receive an AC excitation signal from a controller and to receive a position signal from a position sensor connected to an effector, the position signal being indicative of a position of the effector, the emulator circuit comprising:
means for modulating an amplitude and a frequency of the position signal based on the AC excitation signal to produce a first AC response signal and a second AC response signal;
wherein the first AC response signal and the second AC response signal are configured to be used by the controller for determining the position of the effector.

2. The emulator circuit of claim 1, wherein the means for modulating comprises a first analog amplitude modulator and a second analog amplitude modulator, wherein the position signal comprises a first position signal and a second position signal, wherein the first position signal is an input of the first analog amplitude modulator and the second position signal is an input of the second analog amplitude modulator, wherein the AC excitation signal is an input of each of the first analog amplitude modulator and the second analog amplitude modulator, and wherein the first analog amplitude modulator multiplies the first position signal by the AC excitation signal to produce the first AC response signal and the second analog amplitude modulator multiplies the second position signal by the AC excitation signal to produce the second AC response signal.

3. The emulator circuit of claim 2, wherein the second position signal is inverse to the first position signal.

4. The emulator circuit of claim 2, wherein the first analog amplitude modulator is contained on a single integrated circuit and the second analog amplitude modulator is contained on a single integrated circuit.

5. The emulator circuit of claim 2, wherein the first analog amplitude modulator and the second analog amplitude modulator are constructed with high-temperature transistors.

6. The emulator circuit of claim 2, wherein the first position signal is amplified or attenuated before being input to the first analog amplitude modulator and the second position signal is amplified or attenuated before being input to the second analog amplitude modulator.

7. The emulator circuit of claim 2, wherein the means for modulating comprises a digital signal processor (DSP), a first digital-to-analog converter (DAC), and a second DAC, wherein the position signal is input to the DSP, wherein the DSP produces the first position signal and the second position signal based on the position signal and outputs the first position signal to the first DAC and the second position signal to the second DAC, wherein the first DAC converts the first position signal to a first analog position signal and outputs the first analog position signal to the first analog amplitude modulator, and wherein the second DAC converts the second position signal to a second analog position signal and outputs the second analog position signal to the second analog amplitude modulator.

8. The emulator circuit of claim 2, wherein the AC excitation signal is amplified prior to being input to the first analog amplitude modulator and the second analog amplitude modulator.

9. The emulator circuit of claim 2, wherein the AC excitation signal is phase shifted 180° before being input to the second analog amplitude modulator.

10. The emulator circuit of claim 1, wherein the means for modulating comprises a digital signal processor (DSP), a first digital-to-analog converter (DAC), a second DAC, and an analog-to-digital converter (ADC), wherein the ADC converts the AC excitation signal to a digital excitation signal and outputs the digital excitation signal to the DSP, wherein the position signal is input to the DSP, wherein the DSP produces a first digital position signal and a second digital position signal based on the position signal and the digital excitation signal and outputs the first digital position signal to the first DAC and the second digital position signal to the second DAC, wherein the first DAC converts the first digital position signal to a first analog signal and outputs the first analog signal as the first AC response signal to the controller, and wherein the second DAC converts the second digital position signal to a second analog signal and outputs the second analog signal as the second AC response signal to the controller.

11. The emulator circuit according to claim 10, wherein the AC excitation signal is amplified before being input to the ADC.

12. The emulator circuit according to claim 10, wherein the second digital position signal is inverse to the first digital position signal.

13. A system, comprising:
a controller configured to output an AC excitation signal and receive a first AC response signal and a second AC response signal, the controller configured to determine a position of an effector based on the first AC response signal and the second AC response signal;
a position sensor configured to be connected to the effector, the position sensor configured to output a position signal based on the position of the effector; and
an emulator circuit configured to modulate an amplitude and a frequency of the position signal based on the AC excitation signal to produce the first AC response signal and the second AC response signal.

14. The system according to claim 13, wherein the controller comprises a first terminal and a second terminal configured to produce the AC excitation signal and wherein the emulator circuit comprises a first impedance matching circuit configured to mimic a primary coil of a variable differential transformer, wherein the first impedance matching circuit is disposed between the first terminal and the second terminal.

15. The system according to claim 13, wherein the controller comprises a third terminal, a fourth terminal, and one or more ground terminals, wherein the third terminal is configured to receive the first AC response signal, wherein the fourth terminal is configured to receive the second AC response signal, wherein the emulator circuit comprises a second impedance matching circuit configured to mimic a first secondary coil of a variable differential transformer, wherein the second impedance matching circuit is disposed between the third terminal and the one or more ground terminals, and wherein the emulator circuit comprises a third impedance matching circuit configured to mimic a second secondary coil of the variable differential transformer, and wherein the third impedance matching circuit is disposed between the fourth terminal and the one or more ground terminals.

16. The system according to claim 13, comprising a plurality of isolation transformers disposed between the emulator circuit and the controller.

17. The system according to claim 13, wherein the position sensor is an ultrasonic sensor, a Hall effect sensor, an eddy current sensor, a capacitive displacement sensor, an inductive sensor, a laser Doppler vibrometer, a photodiode array, a piezoelectric transducer, a position encoder, a potentiometer, an optical proximity sensor, or a string potentiometer.

18. A method, comprising:
first outputting an AC excitation signal from a controller to an emulator circuit;
second outputting a position signal from a position sensor to the emulator circuit, the position sensor being connected to an effector;
modulating an amplitude and a frequency of the position signal to produce a first AC response signal and a second AC response signal;
inputting the first AC response signal and the second AC response signal to the controller;
determining by the controller a position of the effector based on the first AC response signal and the second AC response signal.

19. The method of claim 18, wherein the first outputting further comprises outputting the AC excitation signal to a first analog amplitude modulator and to a second analog amplitude modulator;
wherein the second outputting further comprises outputting the position signal comprising a first position signal and a second position signal;
wherein the first position signal is an input of the first analog amplitude modulator and the second position signal is an input of the second analog amplitude modulator; and
wherein modulating further comprises multiplying the first position signal by the AC excitation signal at the first analog amplitude modulator to produce the first AC response signal and multiplying the second position signal by the AC excitation signal at the second analog amplitude modulator to produce the second AC response signal.

20. The method of claim 19, wherein the emulator circuit comprises a digital signal processor (DSP), a first digital-to-analog converter (DAC), and a second DAC;
wherein the second outputting further comprises outputting the position signal to the DSP;
wherein modulating further comprises:
producing, by the DSP, the first position signal and the second position signal based on the position signal;
outputting the first position signal to the first DAC and the second position signal to the second DAC;
converting, by the first DAC, the first position signal to a first analog position signal;
converting, by the second DAC, the second position signal to a second analog position signal; and
outputting the first analog position signal to the first analog amplitude modulator and the second analog position signal to the second analog amplitude modulator.

21. The method of claim 18, wherein the emulator circuit comprises a digital signal processor (DSP), a first digital-to-analog converter (DAC), a second DAC, and an analog-to-digital converter (ADC);
wherein the first outputting further comprises converting, by the ADC, the AC excitation signal to a digital excitation signal and outputting the digital excitation signal to the DSP;
wherein the second outputting further comprises outputting, by the position sensor, the position signal to the DSP;
wherein modulating further comprises:
producing, by the DSP, a first digital position signal and a second digital position signal based on the position signal and the digital excitation signal;
outputting the first digital position signal to the first DAC and the second digital position signal to the second DAC;
converting, by the first DAC, the first digital position signal to a first analog signal; and
converting, by the second DAC, the second digital position signal to a second analog signal;
wherein inputting further comprises:
outputting, by the first DAC, the first analog signal as the first AC response signal to the controller; and
outputting, by the second DAC, the second analog signal as the second AC response signal to the controller.

22. The method according to claim 18, further comprising isolating the emulator circuit from the controller via a plurality of isolating transformers.
